(19) United States
(12) Patent Application Publication
(10) Pub. No.: US 2003/0117262 A1
(43) Pub. Date: Jun. 26, 2003

(54) Encrypted biometric encoded security documents

(75) Inventors: Pierre-Yves Anderegg, Lausanne (CH); Hans-Jorg Hirsch, Preverenges (CH)

Correspondence Address: Mr. John Moetteli, BUGNION, S.A., Case Postale 375, Geneva, CH-1211, CH

(73) Assignee: KBA-Giori S.A., Lausanne (CH)

(21) Appl. No.: 10/166,208

(22) Filed: Jun. 10, 2002

Related U.S. Application Data
(60) Provisional application No. 60/357,595, filed on Feb. 15, 2002.
(60) Provisional application No. 60/343,096, filed on Dec. 21, 2001.

(51) Int. Cl. H04Q 1/00

(52) U.S. Cl. 340/5.53

(57) ABSTRACT

A travel permissions communication interface system is provided, having a scanner, a identifying characteristic reader, a computer, a comparator, a connection device, and a display, all of which being managed by a computer operably connected therebetween. The scanner (a) reads a portable identification carrier onto which is encoded identifying characteristic data of at least one person; (b) sends such identification data to the computer for verification of authenticity of the carrier and (c) extracts a identifying characteristic of a certain identifying characteristic parameter from the identifying characteristic data encoded on the carrier. The identifying characteristic reader reads a same identifying characteristic parameter of the person purported to be identified by the carrier. The comparator compares the encoded identifying characteristic with the extracted identifying characteristic to authenticate the person associated with the carrier. The connection means, if the carrier and at least one person are authenticated, enables the computer to connect to a data storage device of travel permissions associated with that person or type of person. The display displays the travel permissions to an authority to aid the authority in determining a disposition with regard to the person. A method of using a travel permissions communication interface system is also disclosed.

### BACKGROUND OF THE INVENTION

This invention relates to security printing solutions, and, more particularly, to documents coded with high-data density, such as biometric information, for security purposes.

Smart cards have been used to store personal information and even biometric information about their owners to facilitate electronic transactions. For example, U.S. Pat. No. 6,219,439, the content of which is incorporated herein by reference, describes such a smart card. Here, information is stored on a chip embedded within the smart card.

Further, U.S. Pat. No. 6,219,439 describes a identifying characteristic authentication system using a smart card having stored physiological data of a user on a chip disposed therein, and a fingerprint scan (or retina scan, voice identification, saliva or other identifying characteristic data) for comparison against the stored data. The system is self-contained so that the comparison of the identifying characteristic data with the data stored on the chip is done immediately on board the reader without relying upon communications to or from an external source in order to authenticate the user. This arrangement also prevents communication with external sources prior to user authentication being confirmed, so as to prevent user data from being stolen or corrupted.

U.S. Pat. No. 6,101,477, the content of which is incorporated herein by reference, describes a smart card for travel-related use, such as for airline, hotel, rental car, and payment-related applications. Furthermore, memory space and security features within specific applications provide partnering organizations (e.g., airlines, hotel chains, and rental car agencies) the ability to construct custom and secure file structures.

Watermarks have been used for many years on currency and other articles in order to ensure authenticity. A system for watermarking documents is described in WO 00/07356, the content of which is incorporated by reference. Security documents (e.g. passports, currency, event tickets, and the like) are encoded to convey machine-readable multi-bit binary information (e.g. digital watermark), usually in a manner not alerting human viewers that such information is present. The documents incorporate overt or subliminal calibration patterns which when scanned (e.g. by a photocopier), the pattern facilitates detection of the encoded information notwithstanding possible sealing or rotation of the scan data. The calibration pattern can serve as a carrier for the watermark information, or the watermark can be encoded independently. A passport processing station responsive to such markings can use the decoded binary data to access a database having information concerning the passport holder. Some such apparatuses detect both the watermark data and the presence of a visible structure characteristic of a security document (e.g., a printed seal of the document's issuer). Nevertheless, no specific biometric data is described. Neither is the use of a data carrier in the form of a barcode described. Digital signatures or certificates are now often used to authenticate documents.

U.S. Pat. Nos. 5,912,974 and 6,131,120, the contents of which are incorporated herein by reference, describe other methods for the authentication of printed documents. In U.S. Pat. No. 5,912,974, segments of an image are associated with a set of rules and a public key for use in authentication.

In U.S. Pat. No. 6,131,120, an enterprise network operating on a wide area network (WAN), and having routers and servers, uses a master directory to determine access rights including the ability to access the WAN through the routers and the ability to access the server over the WAN.

Security, particularly at major airports has become a significant concern, especially since the tragic events of Sep. 11, 2001. No printable identification is currently available to positively identify a passenger with high reliability. No means is currently available to transmit such information securely and to associate that information with user specific permissions.

U.S. Pat. No. 5,291,560, the content of which is incorporated herein by reference, describes a personal identification system based on iris analysis. U.S. Pat. No. 5,363,453, the content of which is incorporated by reference, describes a personal identification system based on biometric fingerprint data. However, there is no encryption of the biometric information involved.

U.S. Pat. No. 4,972,476, the content of which is incorporated by reference, describes a counterfeit proof ID card having a scrambled facial image, in which the facial image is scrambled using a descrambling control code assigned to the proper user. However, only photographic data is used.

Despite the above efforts, no prior art methods are available for encoding encrypted identifying characteristic information on a printable substrate. No prior art methods are available for encoding identifying characteristic information of related persons on a single printable substrate. In addition, identifying characteristic data is becoming more and more detailed and thus requires either a significant amount of space to record, or, if space is not available (such as on a pocket or credit card size ID card), the amount of stored identifying characteristic data is limited or the resolution of the two dimensional representation must be extremely high.

What is needed therefore is a means of encoding high data-density identifying characteristic information in a printable form within a limited two-dimensional area. In addition, what is needed is a means of authenticating a plurality of data of one person and a plurality of data of multiple persons.

### SUMMARY OF THE INVENTION

A travel permissions communication interface system is provided, having a scanner, an identifying characteristic reader, a computer, a comparator, a connection device, and a disposition device, all of which being managed by a computer operably connected therebetween. The scanner (a) reads a portable identification carrier onto which is encoded identifying characteristic data of at least one person; (b) identification data is then sent to the computer for verification of authenticity of the carrier and (c) an identifying characteristic of a certain identifying characteristic parameter is extracted from the identifying characteristic data encoded on the carrier. The identifying characteristic reader reads a same identifying characteristic parameter of the person purported to be identified by the carrier. The comparator compares the encoded identifying characteristic with the extracted identifying characteristic to authenticate the person associated with the carrier. The connection device, if said carrier and at least one person are authenticated, enables the computer to connect to a data storage device of travel permissions associated with that person or type of person. The disposition device dispositions the person by, for example, displaying the travel permissions to an authority to aid the authority in determining a disposition with regard to the at least one person or automatically generating a disposition action

In another feature, a method of using a travel permissions communication interface system is provided.

In another feature, a portable identification carrier reading and decoding device is provided which reads and decodes an encoded, encrypted identifying characteristic on a portable identification carrier.

An object of the invention is to provide global interoperability through use of printed document format not unlike existing documents.

Another object of the invention is to provide improved document security through information encryption.

Another object of the invention is to provide an article that enables positive identification (verification that the presenter of the document is the rightful holder) through the use of highly reliable identifying characteristic information, such as biometric fingerprint, retina scan, voice identification, saliva, iris recognition, facial recognition, or other identifying characteristic data. A functional identifying characteristic identity system requires the storage of a substantial amount of machine-readable digital data.

Another object of the invention is a printed storage device for digital data, such as e.g. a bi-dimensional barcode, with increased data capacity in a given space and at a given image resolution.

Another object of the invention is to provide a decoding method for the above-mentioned printed storage device.

Another object of the invention is to provide a technology that is applicable on several products including passports, visas, and other travel or identity documents.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of the system of the invention.

FIG. 2 is a plan view of an identification carrier of the invention.

FIG. 3 is a plan view of a primary color identification carrier of the invention.

FIG. 4 is a gray scale representation of the component magenta identification carrier of the invention.

FIG. 5 is a gray scale representation of the component cyan identification carrier of the invention.

FIG. 6 is a gray scale representation of the component yellow identification carrier of the invention.

FIG. 7 is a plan view of an alternate embodiment of an identification carrier of the invention.

FIG. 8 is a plan view of another alternate embodiment of an identification carrier of the invention.

FIG. 9 is a flow chart of a decoding method of the invention

FIG. 10 is a flow chart of the method of the invention.

FIG. 11 is a more detailed flow chart of the method of the invention.

FIG. 12 is a flow chart of a logical security method of the invention.

FIG. 13 is a plan view of a primary color coded identification carrier of a female person.

FIG. 14 is a plan view of a multi-color coded identification carrier of a child.

FIG. 15a is a yellow 2-D barcode of the invention.

FIG. 15b is a magenta 2-D barcode of the invention.

FIG. 15c is a cyan 2-D barcode of the invention.

FIG. 16 is a two color 2-D barcode of the invention.

FIG. 17 is a three primary color 2-D barcode of the invention

### DETAILED DESCRIPTION OF THE PREFERRED EMBODIMENT

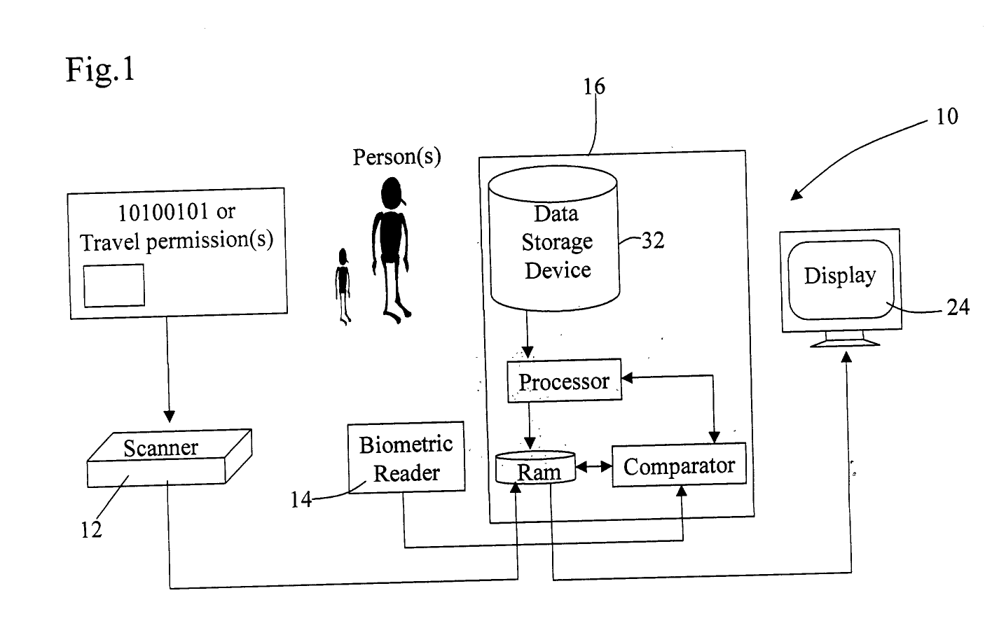

Referring now to FIG. 1, a travel permissions communication interface system 10 is provided, having a scanner 12, an identifying characteristic reader 14 reading identifying characteristic data 15, a computer 16, a comparator 20, connections 22, and a display 24, all of which being managed by a computer 16 operably connected therebetween by 110 data lines, whether wireless (e.g., “BLUETOOTH”™) or network, by serial, parallel, UBS, pcs cable, or other connection. Identifying characteristics are characteristics of a person, including biometrics, legal status, permissions, education, licenses, familial relations, health information, or any other data associated with the individual. Biometric data 15 includes any data representative of a biological structure unique to an individual excepting conventional photographic data. Identifying characteristics are usually rendered in binary form. So too is biometric information, which generally defines certain reference points measured from the biometric structure. Examples of biometric data include iris scan data, retinal scan data, voice identification, saliva, fingerprint data, facial form data, hand form data, and individual DNA data. The scanner 12 (a) scans zones of a portable identification carrier 30 onto which is encoded identifying characteristic data of at least one person; (b) such identification data 15 is sent together with carrier data to the computer 26 for verification of authenticity of the carrier 30 and extraction of a identifying characteristic of a certain identifying characteristic parameter from the identifying characteristic data 15 encoded on the carrier 30. The identifying characteristic reader 14 reads a same identifying characteristic parameter of the person purported to be identified by the carrier 30. The comparator 20 compares the encoded identifying characteristic with the extracted identifying characteristic to authenticate the person associated with the carrier. The connections, if said carrier and at least one person are authenticated, enables the computer 16 to connect to a data storage device 32 of travel permissions associated with that person or type of person. The disposition device dispositions the person or type of person. A disposition device may be a display device 24 connected to a record of dispositions associated with the person or type of persons sought to be authenticated. An authority may then read the proposed dispositions. The display device displays the travel permissions to an authority to aid the authority in determining a disposition with regard to the at least one person.

With travel permission documents, the type of person is determined based on the nationality of the person, their wanted status or social responsibility.

Preferably, the encoded identifying characteristic data is encrypted prior to being encoded onto a data storage device in the carrier. The data storage device is a graphical representation of the associated identifying characteristic readable by the scanner. The carrier is a printable substrate. The graphical representation is preferably printed on the substrate with security ink. The graphical representation is preferably a two dimensional barcode.

The storage device stores personal data such as travel permissions in a secure manner. The travel permissions for example define the legal relationships between the persons, such as guardian, parent, etc. These permissions are preferably encrypted and encoded on the travel document or on a database, accessible automatically upon the presentation of a passport that is itself printed with a 2D barcode of encrypted identifying characteristic information. A function may be applied to the identifying characteristic data of interrelated persons to define a single graphical representation of these persons, including the associated permissions.

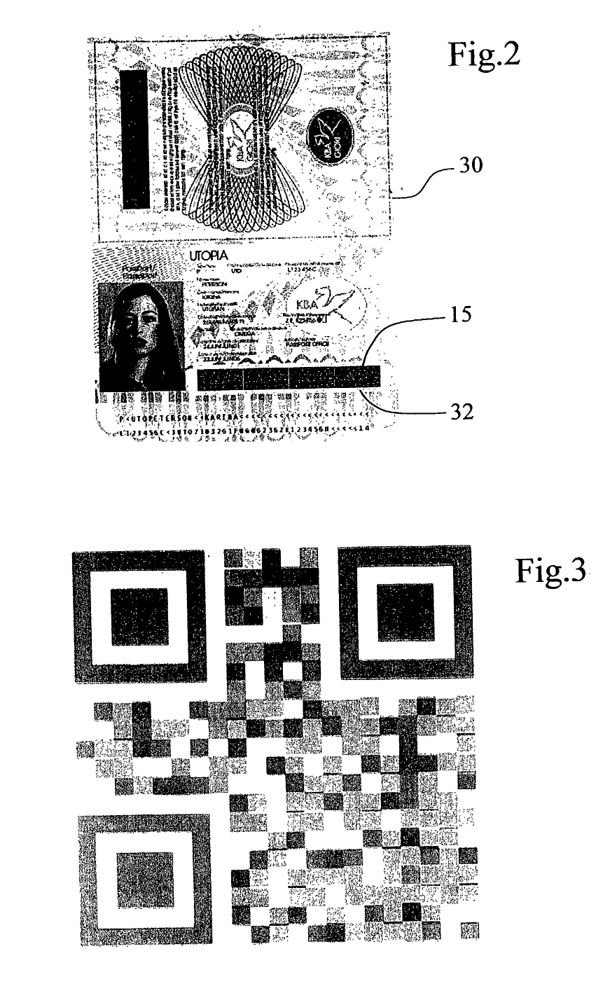

Referring now to FIG. 2, a machine-readable travel document is provided. The machine-readable document is provided with a 2D barcode in which a alphanumeric string is converted into a two dimensional black and white scannable representation.

The identifying characteristic data of two persons is encoded on a 2D barcode in black or of only a single primary color. This can be obtained by simple superposition of the encoded, encrypted bar code images wherein a known-to-the-decoder set of rules is applied to determine the common pixel elements of the barcode. For example, only where each barcode has two black pixels, does the resulting image have a black pixel and only where two blank pixels exist, does the common resulting image have a white pixel. All other combinations are ignored. This creates a unique barcode representative of the two individuals. Thus, where the common elements are identified on a parent or child's travel document, positive identification of each party and their relationship can be obtained. The common elements may be printed separately, in magenta, for example, along with the other elements, in black and white. In this case, a scanner is used which cannot discern between black and a primary color, such as magenta, or which simply counts these colors as the same for the purpose of determining the identity of the travel document holder. The scanner's sensitivity is then changed to read say magenta only, which enables the scanner to pick up the combined barcode representing the common elements of the child and the parent, thus allowing a comparison with the barcode of the child to be made to verify the identity of the parent.

Where a color 2D bar code is used, much more detailed identifying characteristic data (biometric, together with detailed personal information and permissions) may be encoded as a scanner reads more than 256 colors. Potentially, each pixel can have any of 256 different values, greatly expanding the data-carrying capacity of a 2D barcode. Because of the added dimension of color, one can refer to color 2D barcodes as a sort of 3D barcode. Due to its high data carrying capacity, such color barcodes can be used as a 1-byte or 1 kbyte barcode and may be composed of any combination of colors.

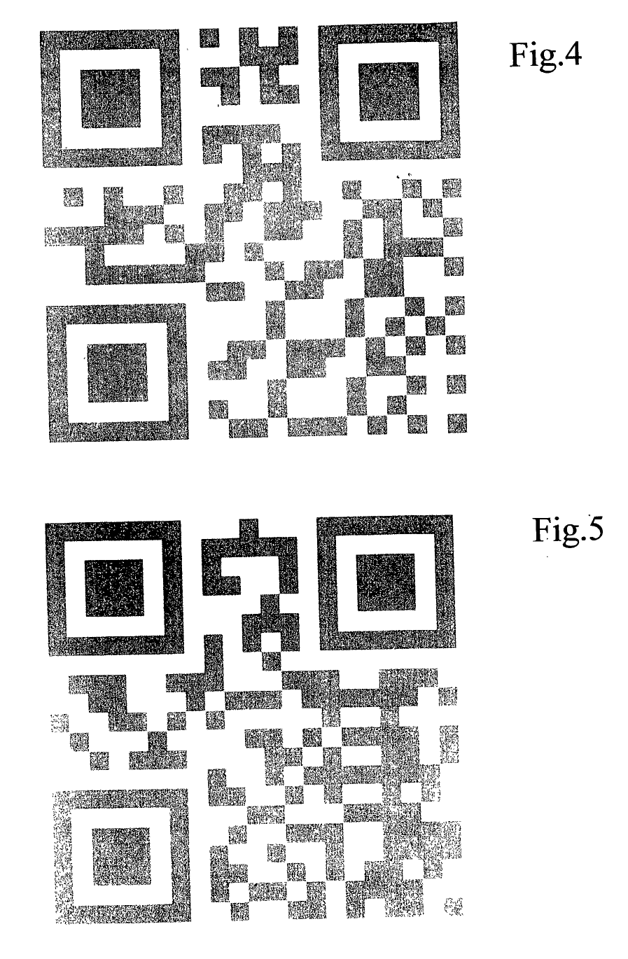

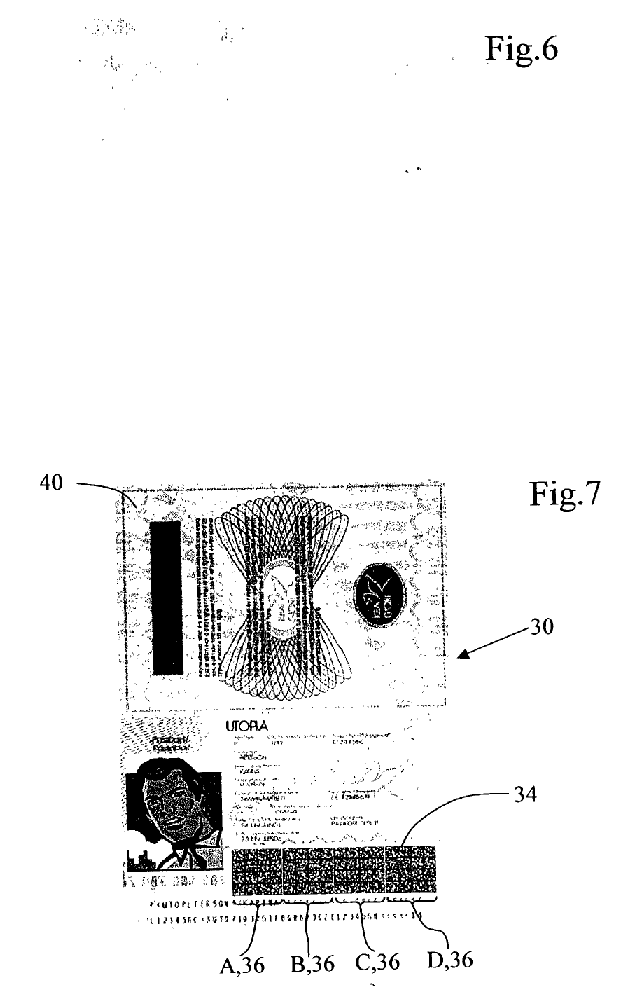

Referring now to FIG. 3, in another embodiment, the color two-dimensional bar code may be composed of a combinations of primary colors Cyan, Magenta, and Yellow. In such an embodiment in which each person is represented by a single 2D barcode in a primary color, these discrete, single color barcodes (e.g., those shown in FIGS. 4 to 6), can be combined and superimposed to create the multi-color barcode of FIG. 3, storing the identifying characteristic information of up to three persons.

In the case of multi-colored barcodes, the scanner 12 filters out each color of the barcode with the help of digital or optical filters in order to decompose the 3D-barcode into 3 individual barcodes storing information on up to three individuals. It should be noted however that the combination of the three primary colors yields eight basic colors, plus one, no color (white), for a total 9. Thus, scanners sensitive to these colors can filter out information on up to nine persons. These colors may be in the visible spectrum or in the ultraviolet, or other spectrum invisible to the human eye. If in the invisible spectrum, the barcode can extend over already printed data in the visible spectrum. Such a storage medium may have significantly increased data capacity in a given space and at a given image resolution due to the fact that colors in the invisible spectrum can overlap an area printed in the open (i.e., printed in visible form on the carrier) with regular textual or photographic data.

Referring now to FIG. 7, in an embodiment, each barcode 34 on the travel authorization is located in a specific field 36 of the identification substrate 40. The identification substrate 40 in this example is one for a child. A child barcode A is consistently located in field A. The child's travel permissions barcode B (giving or denying authorization for certain travel permissions) is located below, in field B, a mother barcode (with permission information) is located in field C, above a father barcode D. Where these authorizations are placed according to a defined set of rules, there can be no confusion about who is who, about where to read the information and about the permissions given.

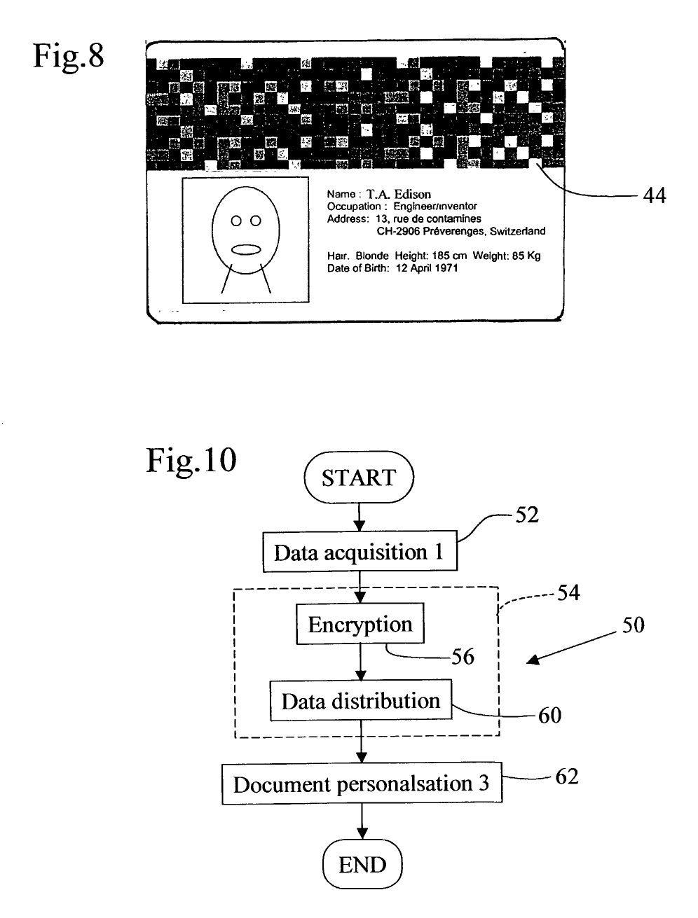

Referring now to FIG. 8, in another embodiment, a single barcode 44 is provided which is large enough and fine enough to store the identifying characteristic data of a family, including travel permissions.

A Color barcode 44 (shown in gray scale in FIG. 8) may be used. The number of colors that can be used depends on printing method and scanner recognition, a good scanner can read 256 colors or more. Thus, where no superimposition of individual barcodes is performed, each pixel can have a unique color assigned to it. In this way, information can be stored about any number of related individuals, depending only on the resolution of the colors making up the barcode and the sensitivity of the scanner 12. The quantity of information held in the barcode is multiplied by the number of printable and readable colors.

In another embodiment, the printed storage medium 30 includes a several layers of information stored in discrete, superimposed printing layers of information represented in a binary representation format (e.g., black and white 2D barcode representation), each layer storing information represented in a selected color. These colors may be in the visible spectrum or in the ultraviolet, or other spectrum invisible to the human eye. If in the invisible spectrum, the barcode can extend over already printed data in the visible spectrum. Such a storage medium has significantly increased data capacity in a given space and at a given image resolution.

In a variant of the above embodiment (not shown), each information layer may be printed on a transparent plastic laminate sheet that, together with superimposed laminate sheets printed with different colors, are fused together to make up a single laminated document. Still further, each laminate can be made of translucent colored material on which information is coded by removing material (by punching, for example) from the laminate in the area or zone in which data is to be stored. The composite of all colored laminates together creates the multicolor storage medium, thus eliminating the need of printing the colors on each laminate.

Further, because the data storage zone may be transparent, the data can be more readily read by passing light (preferably laser light) through the data storage area from the other side of the area in a similar manner as light rays passing through a stained glass window.

It should be noted that superposition of 2D barcode data of different individuals preferably takes place digitally so as to create a single, multi-color layer to be printed or applied to the carrier 30. Although physically possible to apply each color layer to the card separately, this can cause register problems-digitally combining in a single multi-color layer overcomes these problems. This applies as well to a 3D multicolor barcode for application to the carrier 30 by any conventional method.

Any number of printing methods may be used. For example, thermo-transfer, die diffusion, offset digital, inkjet, photographic, bubble jet, letter press, topography, and laser printing and/or engraving may be used, provided that its characteristics are appropriate to efficiently printing variable information to a document.

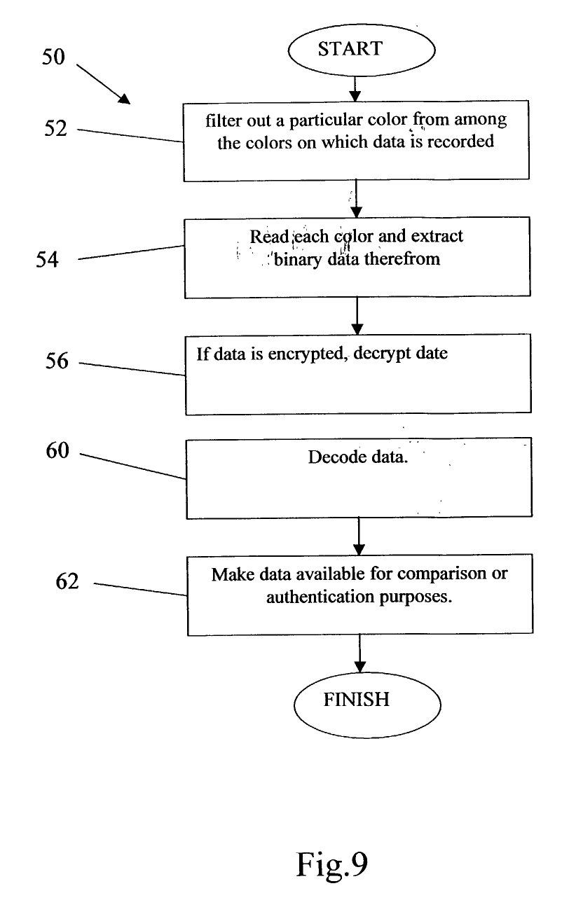

Now referring to FIG. 9, a decoding method 50 for the above-mentioned printed storage device is also provided. This decoding method 50 is made up of the following steps. In a first step 52, a digital or optical color filter (not shown) is used to filter out a particular color (whether visible or invisible) from among the colors on which data is recorded. In a second step 54, each color is then read and the binary data extracted therefrom. In a third step 56, if the data was encrypted, the encrypted binary data is decrypted. In a fourth step 60, the decrypted data is decoded. In a fifth step 62, the decoded data is made available for comparison or authentication purposes. Thus, the method 50 permits the reading of information by first separating the different layers of information through the use of a digital or optical color filter, followed by the decoding of the binary information of every individual layer.

In another embodiment, identifying characteristic data may be represented in three-dimensional form via a three-dimensional laser etching/machining or machined into a etchable substrate such as the carrier 30. In this embodiment, reading of the three dimensional representation of identifying characteristic data is accomplished, for example by a laser reader that reads and maps the relative depths of the three dimensional contours cut by the laser engraving or machining. In a variation of this embodiment, the substrate is a laminate of layers of different colored material, the etching depth revealing a particular color representative of the data to be stored. Preferably, to protect the three-dimensional etching from contamination from dirt and other contaminates, the etched contour is filled with an at least translucent resin. In still another variant of this embodiment, the etched contour or relief may be filled with a material which is opaque to visible light, but which is transparent or translucent to certain wavelengths of invisible radiation, and thus readable by an emitter of such radiation. It should be noted that in this embodiment, all textual data can be encrypted and encoded and the three dimensional identifying data can be a representation of a retinal scan, the security of this medium being that it otherwise cannot be associated with the carrier because there need not be visible, recognizable identifying characteristic data imprinted on the carrier.

The method of the invention converts encrypted identifying characteristic information into machine-readable 2D or 3D barcodes imprinted on a substrate referred to herein as a travel document. 2D barcodes are known for use with fingerprint identifying characteristic, for which a large database has already been established. A high-density 2D barcode (including so-called 3D color barcodes) have many benefits in this application. They are machine-readable. They use “QR”, “DATAMATRIX”, or similar code protocol, from the public domain, thus allowing for broad interchangeability of parts (readers are available from multiple sources to achieve low cost).

Barcoded information can first be encrypted, thus enhancing security. Further, a surface area of 18.35 mm×80.0 mm can hold more than 5 Kbytes (depending on the resolution and the scanner sensitivity used) of information, enough to hold a wide range of identifying characteristic data.

Encryption of the identifying characteristic data stored in a bar code ensures that personal, indelible data does not become known outside of a secure, controlled environment. Counterfeiting therefore becomes virtually impossible. Encryption may be carried out using the Public Key Infrastructure, a proven method of secure data transmission.

In addition, by virtue of the increased data capacity, other variable, unique digital information related to the holder or the document can be encrypted and encoded in the machine-readable data storage device. Thus a security feature related to the content of the document can be implemented by verifying the consistency of the data between the encrypted and encoded data and the data printed in the open (e.g. photographic, demographic or document related information). The algorithms for comparing the encrypted information from the data storage device with that same information printed in the open may be implemented in the document reading device.

The invention can encode in 2D form various types of identifying characteristic information. The use of a biometric system such as iris recognition is highly recommended because of its reliability. Iris recognition devices suitable for integration with the invention are available from IRIDIAN TECHNOLOGIES of Moorestown, N.J. and Geneva, Switzerland.

Finger print recognition devices suitable for integration in the invention are also available. Guardware Systems Ltd. of Budabest, Hungary, provides a suitable device.

Any suitable encryption method can be applied to the system and method of the invention. For example, Public Key Infrastructure can be used (i.e., asymmetric encryption). Such an encryption method is used many times daily for secure payments in numerous paperless banking and Internet transactions.

Integral to the system of the invention is a portable identification carrier reading and decoding device that reads and decodes an encoded, encrypted identifying characteristic on a portable identification carrier. The device includes a scanner, a processor, and a comparator. The scanner reads the encrypted identifying characteristic and transmits the read data to the processor for processing. The processor decrypts the identifying characteristic and transmits the decrypted identifying characteristic on to the comparator. The comparator compares this data with identifying characteristic data of the same type read from a person purported to be associated with the carrier, in order to verify the person's identity.

The Method

Referring now to FIG. 10, the method 70 of the invention broadly involves the steps of (1) data acquisition, (2) secure data distribution, and (3) document personalization. In a data acquisition step 72, the identifying characteristic reader 14 is used to capture identifying characteristic data of an individual. This step is usually implemented in a decentralized manner, meaning, the individual need only go to a local authority for this basic information gathering-it is not necessary to travel to one central location within the jurisdiction to initiate the method. Preferably, a trusted authority is present to observe the data acquisition process, certifying in some form that, upon presentation of other conventional information, such as a birth certificate, marriage certificate, drivers license or passport, the identity of the person to be scanned is as purported by the individual. In the secure data distribution step 74 the acquired data is preferably first encrypted using, for example, the PKI infrastructure. The encryption substep 76 is necessary when such data will be stored in a centralized manner, particularly when the identity authentication task takes place decentrally. The data may then be distributed in a data distribution substep 80. In the document personalization step 82, additional information such as permissions or travel restrictions may be added to the document. Personalization can be carried out in two modes that are centralized or decentralized.

Centralized personalization requires that either (1) the individual travel to a centralized location or (2) information gathered in a decentralized manner be transmitted in a secure fashion to the central location. In the event of decentralized acquisition of the data, the transmission to the central location requires encryption if such is to be transmitted to the central location electronically. Use of the PKI infrastructure is suitable for this purpose. At the central location, databases of information about the individual that's in the custody of the government or other organization may be associated with the acquired data, to define limitations or provide permissions associated with the individual. For example, persons on parole may be restricted from leaving a country in violation of the parole terms. A father may be restricted from leaving a country with his child, if the acquired data is annotated with information restricting him from such travel. Centralized personalization has the advantage that the facility can be customized for a particular purpose and be outfitted with expensive but highly productive equipment (such as industrial digital printers) which permits high volume, high quality production. Centralized personalization permits a unique, secure facility for data encryption and coding, does not involve the risks associated with transporting blank documents to decentralized locations, and permits the use of expensive but highly reliable security devices, due to the high volume upon which to justify the expense. Decentralized personalization, although it permits instant delivery of the travel document, requires many smaller, less efficient, less secure centers for travel document production. The technology used in such decentralized systems includes office-printing technology such as laser or inkjets.

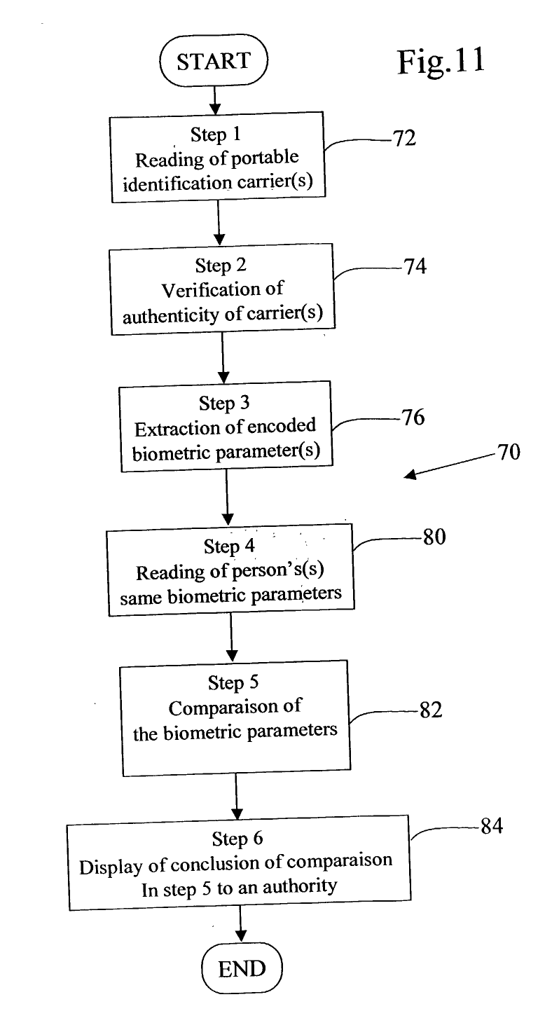

Referring now to FIG. 11, in another embodiment, a method 90 of using a travel permissions communication interface system 10 is provided. The method of use comprises essentially six steps. In a first step 92, a portable identification carrier onto which is encoded identifying characteristic data of at least one person is read. In a second step 94, such identification data is sent to the computer 16 for verification of authenticity of the carrier. In a third step 96, an biometric of a certain biometric parameter is extracted from the biometric data encoded on the carrier. In a fourth step 100, a same biometric parameter is read of the at least one person purported to be identified by the carrier. In a fifth step 102, the encoded biometric is compared with the extracted biometric to authenticate the at least one person associated with the carrier. If the carrier and the persons encoded on the carrier are authenticated, the computer connects to a data storage device of travel permissions associated with that person or type of person. In a sixth step 104, the travel permissions are displayed to an authority to aid the authority in determining a disposition with regard to the at least one person.

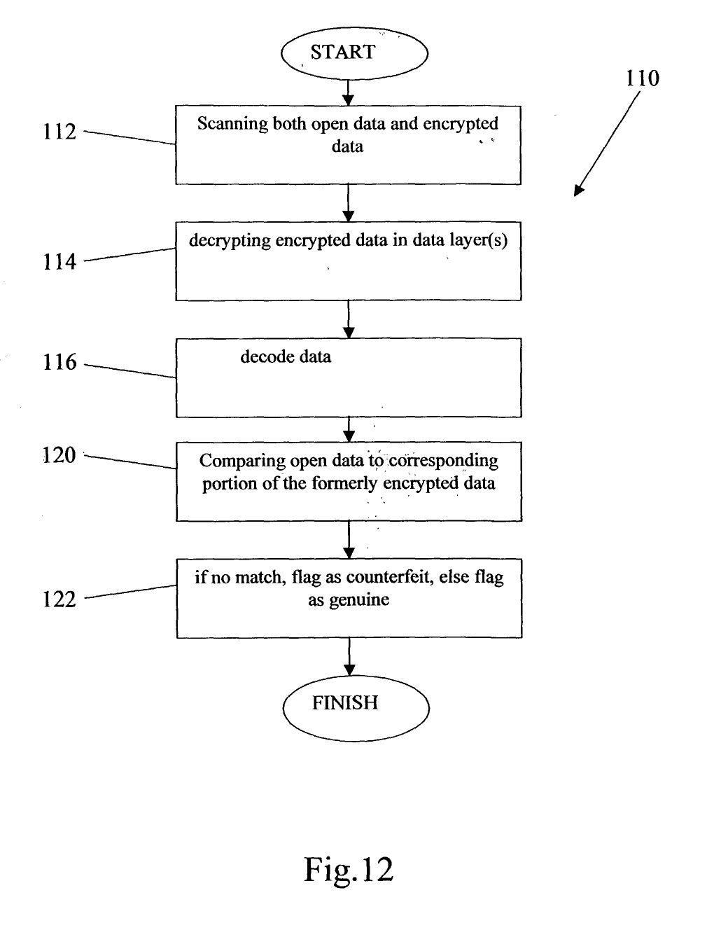

Referring now to FIG. 12, in another embodiment, a logical security verification method 110 establishes the coherence of the information contained within the data storage device in which open data (data printed on the face of the storage device such as document-related, demographic, photographic, and/or biographical information which is not encoded or encrypted) is also encoded and encrypted on the storage device 30 in the binary, machine readable data layers. In a first step 112, the storage device is scanned, the scanner reading both the open data and the encoded encrypted data on the carrier. In a second step 114, the encoded, encrypted data in one or more of the data layers is decrypted. In a third step 116, the decrypted data is decoded. In a fourth step 120, the information applied to the storage device in the open is compared to that portion of the encrypted, encoded data in which the open data is stored. In a fifth step 122, if the data do not match, the storage device is flagged as counterfeit, and if the data do match, the storage device is flagged as genuine. This method 110 makes tampering and counterfeiting evident by comparing the information encrypted in the data storage device with the same information printed in the open.

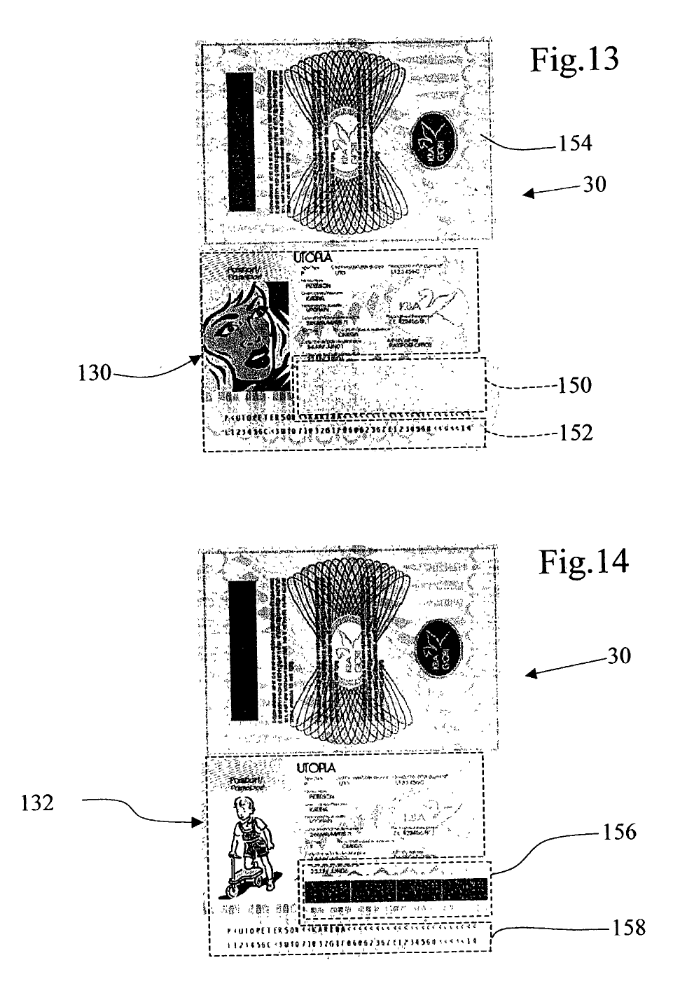

Now referring to FIG. 13, a primary color-coded identification carrier 30 of a female person 130 has a 3D data zone 150 and open data 152. The identification carrier 30 is a printed security paper 154.

Now referring to FIG. 14, a multi-color coded identification carrier 30 of a child 132 has a 3-D data zone 156 and open data 158.

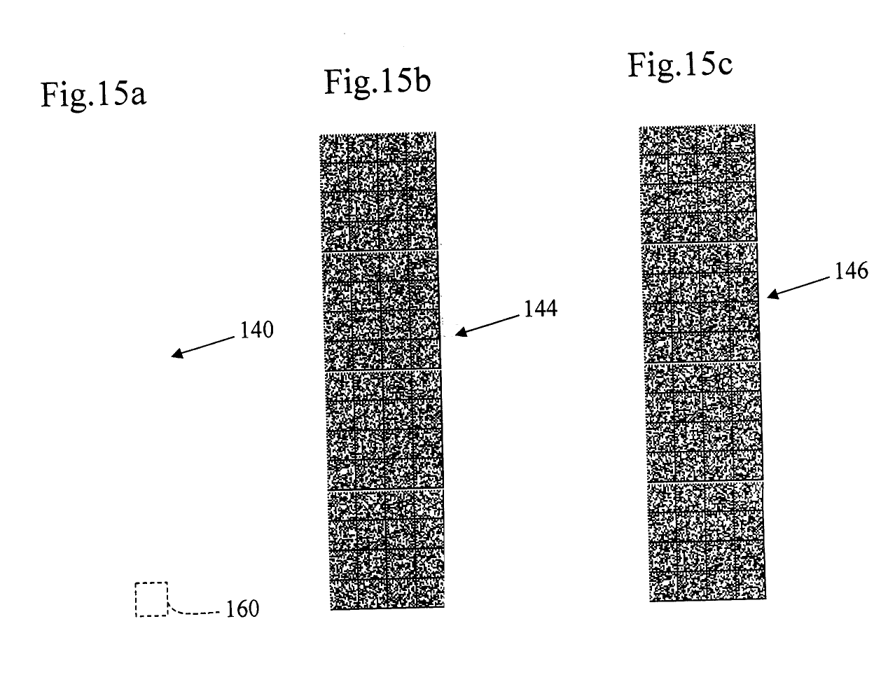

Now referring to FIG. 15a, a yellow 2-D barcode 140 is made up of multiple data areas 160. FIGS. 15b-15c show a magenta and a cyan 2-D barcode 144 and 146, respectively.

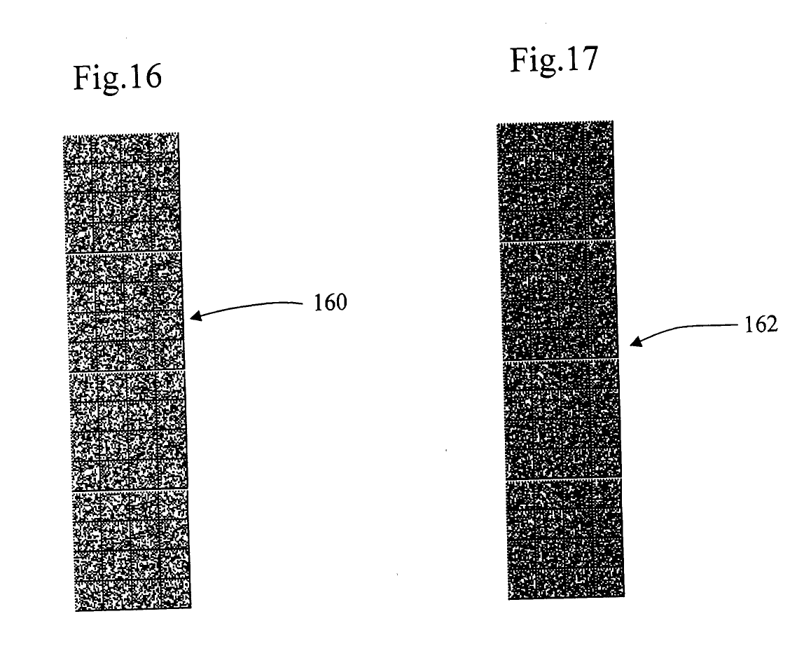

Now referring to FIG. 16, a two color 3-D barcode 1604 is made up of digitally superimposed yellow and magenta 2-D barcodes. FIG. 17 refers to a three primary color 3-D barcode 162.

Examples of Use

Although the invention is useful in any industry (e.g., packaging, supermarkets, etc.), the invention is particularly applicable to improve control of the passage of individuals at a national border. Comparison of the traveler's identifying characteristic feature with decrypted and decoded information from the travel document ensures that the traveler is who he purports to be. This allows those individuals who have high quality characteristics (e.g., feature-comparison match, no exceptions recorded on the travel document or in the permissions database accessed remotely) to pass through the border without necessarily any personal physical interaction (e.g. self service border control processing). Only in the event of an exception, detected for example when the encoded information on the passport does not match read identifying characteristic information, need the border officials get involved, to confirm the determination of the method (this may be necessary due to the fact that identifying characteristics are not 100% reliable).

In another application, although visa documents (MRV) already allow for automatic reconciliation with the passport number using Optical Character Recognition (OCR), it is best to provide a field on the travel document for an optional barcode on MRV-A type documents (see ICAO document 9303 or corresponding ISO standard), so that consistent authentication using machine readable, encrypted identifying characteristic templates can be produced with the view to reduce Visa fraud.

In the airline industry, the system and method of the invention is useful to obviate the need for a separate boarding pass document. The passenger need only present his passport and submit himself to an identifying characteristic authentication (such as an iris scan, for example) to enter the airplane. Verification of the fact that one is a traveler could also be conducted at the check out of duty free shops, to ensure that the purchaser qualifies to make the purchase. Again, only if the system identifies exceptions is there a need for human intervention.

Again in the airline industry, luggage can be provided with ID tags having machine-readable identifying characteristic data of the owner thereon (optionally encrypted and encoded), to ensure that only the rightful owner of the luggage can leave the baggage claim area.

In the childcare industry, just as with luggage, children (whether recently born and still in the maternity ward or at a day care center) under the care of a guardian are provided with an encrypted, encoded identifying characteristic tag that matches the child's identifying characteristic information with that of the parent. The invention will therefore provide an identification function that will become more and more important as genetic engineering increases the number of genetically identical individuals. Fortunately, studies have shown that even identical twins have discernible iris and fingerprint patterns. In an alternate embodiment (not shown), the storage device is a remote database storing travel permissions in association with persons in a secure manner.

In an advantage of the invention, global interoperability between ID readers is provided through use of a printed document format similar to existing documents while adhering to existing document standards and reading technologies. This allows countries to individually upgrade their documents for the benefit of machine-readable identifying characteristic features at their time of choice, without compromising interoperability, as it exists today.

In another advantage, improved document security is provided through encryption.

In another advantage, positive identification and verification that the presenter of the document is the person associated with the document is provided, through the use of reliable identifying characteristic information, such as fingerprint and/or iris recognition biometric systems.

In another advantage, the invention is applicable for passports, visas, general Ids, driver's licenses, and other licensing documents.

In another advantage, the invention is low cost.

In another advantage, the handling of passengers at international borders can be automatic, the intervention of an individual being needed only in the event of an exception.

In another advantage, the method and system of the invention can be used to deter child trafficking by including a identifying characteristic template of children into their parent's travel document and vice versa, to ensure that a child cannot be freely transported across national borders without proper identification.

In another advantage, the system and method of the invention permits dynamic access to information such as wanted fugitive information, permitting a local database to be instantaneously updated with wanted information even shortly after the violation for which the fugitive is sought.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. A travel permissions communication interface system comprising a scanner, a identifying characteristic reader, a computer, a comparator, a connection means, and a disposition device,
wherein the connection means operably connects the computer to the scanner, the reader and disposition device,
wherein the scanner reads a portable identification carrier on which is encoded machine-readable, digital identifying characteristic data of at least one person, the carrier comprising layers of binary information, each represented in a different color from either the visible or invisible part of the spectrum;
wherein the computer has:
(a) transmission means to transmit such scanned identifying characteristic data from the scanner to the computer for verification of the authenticity of the carrier, and
(b) logical extraction means to extract an identifying characteristic of a certain identifying characteristic parameter from the identifying characteristic data encoded on the carrier,
wherein the identifying characteristic reader is adapted to read a same identifying characteristic parameter of the at least one person purported to be identified by the carrier,
wherein the comparator compares the encoded identifying characteristic with the extracted identifying characteristic to authenticate the at least one person associated with the carrier;
wherein the connection means, if the carrier and at least one person are authenticated, enables the computer to connect to a data storage device of permissions associated with that person or type of person; and
wherein the disposition device dispositions the at least one person in a prescribed manner.

2. The system of claim 1, wherein the identifying characteristic reader is chosen from a group of identifying characteristic readers consisting of biometric readers, license readers, travel authorization readers, and custody document readers.

3. The system of claim 1, wherein the type of person is determined based on the nationality of the person.

4. The system of claim 1, wherein the encoded identifying characteristic data is encrypted prior to being encoded onto the carrier.

5. The system of claim 1, wherein the data storage device is integrated into the carrier.

6. The system of claim 5, wherein the data storage device is a printed graphical representation of the associated identifying characteristic readable by the scanner.

7. The system of claim 6, wherein the carrier is a printable substrate.

8. The system of claim 7, wherein the substrate is printed with security ink.

9. The system of claim 6, wherein the graphical representation is of an encrypted identifying characteristic.

10. The system of claim 6, wherein the graphical representation is a two dimensional barcode.

11. The system of claim 1, wherein the storage device is a remote database storing permissions in association with persons in a secure manner.

12. The system of claim 1, wherein part of or all of the variable information on the identification carrier is encoded and encrypted in a data storage device on the same carrier.

13. The system of claim 1, wherein identifying characteristic data of at least two persons of which at least one has a legal responsibility for the other, are encoded on the carrier.

14. The system of claim 13, wherein a function is applied to the identifying characteristic data of the at least two persons to define a combined graphical representation of the at least two persons.

15. The system of claim 14, wherein the graphical representation is a two dimensional barcode.

16. The system of claim 15, wherein the two dimensional bar code comprises combinations of primary colors cyan, magenta, and yellow.

17. The system of claim 15, wherein the two dimensional bar code is multi-colored and thus capable of storing the data of a number of persons corresponding to the number of colors in the barcode.

18. The system of claim 14 wherein the identifying characteristic data of each of the at least two persons is encoded on a 2D barcode of only a single primary color.

19. The system of claim 14, wherein the combined graphical representation is comprised of the superposition of the 2D, primary color barcodes of at most three individuals.

20. The system of claim 1, wherein the accessed permissions of the at least two persons relate to responsibilities of one person with respect to another.

21. The system of any one of the above claims wherein the identifying characteristic data is selected from one of a group of identifying characteristic data consisting of iris scan data, retina scan data, fingerprint data, facial form data, hand form data, and individual DNA data.

22. The system of any one of claims 1-20, wherein the permissions may be printed by a method selected from one of a group of methods consisting of offset digital, inkjet, bubble jet, laser printing and laser etching.

23. A method of using a travel permissions communication interface system, wherein the method comprises the steps of:
reading a portable identification carrier onto which is encoded identifying characteristic data of at least one person;
sending such identification data to the computer for verification of authenticity of the carrier;
extracting a identifying characteristic of a certain identifying characteristic parameter from the identifying characteristic data encoded on the carrier;
reading a same identifying characteristic parameter of the at least one person purported to be identified by the carrier,
comparing the encoded identifying characteristic with the extracted identifying characteristic to authenticate the at least one person associated with the carrier;
if the carrier and at least one person are authenticated, enabling the computer to connect to a data storage device of permissions associated with that person or type of person; and
displaying the permissions to an authority to aid the authority in determining a disposition with regard to the at least one person.

24. A computer-readable medium encoded with a method of using a travel permissions communication interface system, the method comprising the steps of:
reading a portable identification carrier onto which is encoded identifying characteristic data of at least one person;
sending such identification data to the computer for verification of authenticity of the carrier;
extracting a identifying characteristic of a certain identifying characteristic parameter from the identifying characteristic data encoded on the carrier;
reading a same identifying characteristic parameter of the at least one person purported to be identified by the carrier,
comparing the encoded identifying characteristic with the extracted identifying characteristic to authenticate the at least one person associated with the carrier;
if the carrier and at least one person are authenticated, enabling the computer to connect to a data storage device of permissions associated with that person or type of person; and
displaying the permissions to an authority to aid the authority in determining a disposition with regard to the at least one person.

25. An identification carrier reading and decoding device which reads and decodes an encoded, encrypted identifying characteristic on a portable identification carrier, the device including a scanner, a processor, and a comparator, wherein the scanner reads the encrypted identifying characteristic and transmits the read data to the processor for processing, the processor decrypts the identifying characteristic and transmits the decrypted identifying characteristic on to the comparator, and the comparator compares this data with identifying characteristic data of the same type read by an identification characteristic reader from a person purported to be associated with the carrier, in order to verify the person's identity and subsequently, if identity is verified, to permit access to corresponding permission data.

26. The device of claim 25, wherein the identifying characteristic reader is chosen from a group of identifying characteristic readers consisting of biometric readers, license readers, travel authorization readers, and custody document readers.

27. An enhanced data storage device for machine-readable, digital data, for use in a portable identification carrier having at least one application surface onto which at least one layer is applied, the layer comprising encoded binary machine-readable, digital identifying characteristic data of at least one person, the data of each person being represented in a different color in the at least one layer.

28. The device of claim 27, wherein the encoded identifying characteristic data is encrypted prior to being encoded onto the carrier.

29. The device of claim 27, wherein the data storage device is integrated in the carrier.

30. The device of claim 29, wherein the data storage device is a printed graphical representation of the associated identifying characteristic readable by the scanner.

31. The device of claim 30, wherein the carrier is a printable substrate.

32. The device of claim 31, wherein the substrate is printed with security ink.

33. The device of claim 30, wherein the graphical representation is of an encrypted identifying characteristic.

34. The device of claim 30, wherein the graphical representation is a two dimensional barcode.

35. The device of claim 27, wherein the storage device is a remote database storing permissions in association with persons in a secure manner.

36. The device of claim 27, wherein part of or all of the variable information on the identification carrier is encoded and encrypted in a digital storage device on the same carrier.

37. The device of claim 27, wherein identifying characteristic data of at least two persons of which at least one has a legal responsibility for the other, is encoded on the carrier.

38. The device of claim 27, wherein a function is applied to the identifying characteristic data of the at least two persons to define a single graphical representation of the at least two persons.

39. The device of claim 38, wherein the graphical representation is a two dimensional barcode.

40. The device of claim 39, wherein the two dimensional bar code is comprised of combinations of primary colors cyan, magenta, and yellow.

41. The device of claim 39, wherein the two dimensional bar code is multi-colored and thus capable of storing the data of a number of persons corresponding to the number of colors in the bar code.

42. The device of claim 38 wherein the identifying characteristic data of each of the at least two persons is encoded on a 2D barcode of only a single primary color.

43. The device of claim 40, wherein the combination is comprised of the superposition of the 2D, primary color barcodes of at most three individuals.

44. The device of claim 35, wherein the accessed permissions of the at least two persons relate to responsibilities of one person with respect to another.

45. The system of claim 27 wherein the identifying characteristic data is selected from one of a group of identifying characteristic data consisting of iris scan data, retina scan data, fingerprint data, facial form data, hand form data, and individual DNA data.

46. The device of claim 35, wherein the permissions may be printed by a method selected from one of a group of methods consisting of offset digital, inkjet, bubble jet, laser printing, laser machining, and laser etching.

47. The device of claim 27 wherein the color is selected from either the visible or invisible part of the spectrum.

48. The device of claim 28 wherein any invisible layer extends over portions of the application surface of the carrier which may be printed with visible, non-encoded identifying characteristic data such as a digital photograph.

49. The data storage device of claim 27 wherein at least two persons are defined in a corresponding number of layers and superimposed digitally to create a single multicolor image which is applied to a substrate.

50. A logical security verification method, the method establishing the coherence of information contained within a data storage device in which open data is also encoded and encrypted on the storage device in binary, machine readable data layers, the method having the following steps:
(a) scanning data zones on the storage device,
(b) reading both the open data and the encoded encrypted data in the data zones of the storage device;
(c) decrypting the encoded, encrypted data read from one or more of the data layers;
(d) decoding the decrypted data; and
(e) comparing the information applied to the storage device in the open to that portion of the encrypted, encoded data in which the open data is also stored; and
(f) if the open data does not match the formerly encoded, encrypted open data, the storage device is flagged as counterfeit, and if the data do match, the storage device is flagged as genuine.
